(19) United States
(12) Patent Application Publication
(10) Pub. No.: US 2004/0078128 A1
(43) Pub. Date: Apr. 22, 2004

(54) Device for electronically controlling a gearbox, particularly an automatic gearbox

(76) Inventors: Bernd Dietzel, Syrgenstein (DE); Richard Burk, Hochdorf (DE); Joachim Ehleiter, Heidenheim (DE)

Correspondence Address: BAKER & DANIELS, 111 E. WAYNE STREET, SUITE 800, FORT WAYNE, IN, 46802

(21) Appl. No.: 10/451,980

(22) PCT Filed: Nov. 27, 2001
(86) PCT No.: PCT/EP01/13779

(30) Foreign Application Priority Data
Dec. 27, 2000 (DE) 100 65 062.7
Mar. 6, 2001 (DE) 101 10 729.3

(51) Int. Cl. G06F 19/00

(52) U.S. Cl. 701/51

(57) ABSTRACT

The invention relates to a device for electronically controlling a drive assembly, particularly a gear box (2), which is used in a vehicle, comprising a control unit (3) associated with the drive assembly and arranged at a spatial distance from the drive assembly, and an identification module (4) which is electronically connected to the control unit and comprises a characteristic memory unit (5) associated with the drive assembly for storing at least the production-related characteristics of controllable devices and components of the drive assembly. The invention is characterised by the following characteristics:

the identification module is arranged in the drive assembly, particularly in the housing thereof and the identification module contains an operational and/or functional data memory unit (6) for storing updated operational data and/or functional data.

The invention relates to a device for electronically controlling a gearbox, particularly an automatic gearbox for use in vehicles, in particular with the features from the generic term of claim 1.

Devices for electronically controlling an automatic gearbox for motor vehicles are known in a multitude of designs. One generic device is described in the publication DE 43 02 248/C2. This device comprises an electronic control unit allocated to an automatic gearbox which is placed in any predetermined position in the vehicle and which is arranged removed from the casing of the gearbox. The device further comprises a properties storage unit for storing manufacturer-contingent properties of controllable devices and components of the automatic gearbox. Said unit is arranged at the casing of the automatic gearbox and electrically connected with the control unit by at least one signal line. This solution makes it possible to feed the manufacturer-contingent properties of the controllable devices and components of the automatic gearbox to any selected control unit, whereby in the engineering of the control device it is not necessary to pay attention to the allocations between the gearbox and the control unit, but rather this data is read out from the properties memory by means of the control unit according to the application. This data is then processed by the control unit used to control the individual gear elements, in particular the switching elements. One disadvantage of such a solution lies in the fact that here, essentially only manufacturer-contingent variables can be made available by the properties memory in the control device. Every exchange of the control device brings about another required adaptation of the data deposited in the properties memory to the concrete application. This is always an advantage when a control unit is replaced by a different type of control unit, since in this case it would only be necessary to access the variables characterizing the properties of the individual components of the gearbox. However, since these variables don't necessarily remain constant from the factory, but rather can undergo a change during the service life, for example through wearout or due to other causes, this changed data and the data that is influenced by it, for example correcting variables for generating contact pressure for switching elements etc. are no longer necessarily available to the newly replaced control unit for processing. This means that an adaptation to the optimum switching performance by means of the selection of corresponding programs in the control unit of the gearbox must first take place all over again. The result is an intermittent poor switching performance. In general, it is normal that operating data or data that changes, for example by means of adaptation over a longer time period, is stored in the control unit. This data would also be lost in an exchange of control units. This would result in, for example, a situation where the newly set correcting variables for switching operations in such an adaptation procedure could not be taken into consideration, but rather the originally set values would be accessed, causing the switching performance over a specific time period to be characterized by unfavorable factors, before they are adjusted by means of the adaptation.

A further disadvantage of this solution lies in the fact that in exchanging a control unit allocated to the gearbox, it would be necessary to read out the operating data recorded in the control unit for assessments that span time, which however in the case of the defect of such a control device is as a rule no longer possible, so that this data is lost.

The invention therefore is based on the object of further developing a device for controlling a gearbox of the initially named type in such a way, that it is ensured that a multitude of data can be securely preserved over a longest possible time period and that an assessment of the switching transactions using the operating data over the entire operating time period is given even in the case of multiple replacements of the control devices allocated to the gearboxes.

The invention's solution is characterized by the features of claim 1 and 2. Advantageous embodiments are described in the dependent claims.

A device for electronically controlling a drive unit, particularly in the form of a gearbox, particularly of an automatic gearbox for use in vehicles, comprises a control unit allocated to the drive unit and arranged at a distance from or for specific applications also on or in the casing of the drive unit. The control unit is electrically connected with an identification module, which comprises a properties memory unit allocated to the drive unit for storage of at least manufacture-conditioned properties of controllable devices and of components of the drive unit. The identification module is arranged in the drive unit in accordance with the invention and contains further an operating and/or functional data storage unit for storage of updated operating data and/or functional data. The properties storage unit and operating and/or functional data storage unit are preferably formed by one physical storage unit.

By drive units, those mechanisms are understood which are involved in the power transfer in the drive strand. Preferably the invention's device for a drive unit is used in the form of a gearbox, whereby the gearbox can be designed as an automatic gearbox or as an automated gear-shift mechanism.

By operating data, that data is understood which characterizes the operation of the drive unit, particularly of the gearbox. This includes for example the service life, run times, specified revolutions, maintenance data etc. By functional data that data is understood which is for one of special significance during the operation for the guaranteeing of the function of the drive unit and that can experience an adaptation related to the function of the drive unit. An example of this kind of data is characteristic data that is formed or results and/or is optimized in adaptation, control and/or regulating operations.

Property data is data that is design-dependent and as a rule is specified during manufacturing. However, this can also change due to tolerances or aging effects, which is why this data can undergo an adaptation during operation of the drive unit.

The solution of the invention makes it possible to implement an option of storing operating data with minimum effort using existing systems, whereby the gear identification system for avoidance of breakdowns through environmental influences is arranged in the casing of the drive unit. The storage of updated operating and/or functional data makes it possible, particularly in the case of the breakdown of the control unit allocated to the drive unit and its replacement by means of a control unit of the same or different type, already at startup of this control unit to at least lay the foundation there of the last gathered operating and functional data, which describes the current actual state. In the process, particularly wearout effects or other interference sources are reflected in this operating data. Corresponding to the operating and/or functional data the selection of the optimum switching program can thereby occur. Adaptations may arise only in the further operation of the drive unit.

The properties storage unit and the operating data storage unit are preferably integrated in one physical unit. In a particularly compact solution the properties storage unit and the operating data storage unit are formed by one physical component in the form of a storage medium. This storage medium is preferably designed as nonvolatile storage in the form of an EEPROM. Data communication requires only an interface which is allocated to the storage medium. Further, this storage medium can also be a component of a microcomputer, which in addition to the memory component also comprises at least a microprocessor, in particular a CPU and a read-only memory for storage of programs as well as a volatile storage medium. Other designs are conceivable.

Under a further aspect of the invention a storage of component parameters or data that undergoes a component-specific adaptation during the operation of the drive unit also takes place in the properties storage unit. This data includes for example the variables of the clutch elements in gearboxes characterizing the wearout of switching elements or the characteristic data having to do with the characterization of the aging effects of oil.

The interconnection between the identification module and the control unit occurs via corresponding resources for data communication and data transfer. The concrete selection depends on the design of the identification module as well as its arrangement in the vehicle.

In a particularly preferred embodiment the resources for communication and data transfer comprise at least one serial interface as well as a supply line. Preferably the supply line is at the same time the line for the communication.

The device for controlling the drive unit can be interconnected with other devices for controlling drive components for the purpose of data exchange. There is also the possibility of having this device be subordinate to a central control device, which for example corresponds to a device for controlling the vehicle and is also termed as the central control unit, or to have this device integrated in a control device for controlling the vehicle. The connection to other control devices can take place by means of a data communication network, for example a so-called CAN bus.

Since as a rule very high temperatures predominate in the drive units, particularly the drive units of a gearbox or in its proximity, which make the use of electronic components problematic, since they can automatically lead to a reduced service life of the overall system, the identification module is not activated continuously, but rather only for short periods of time, for example when the control device is supplied with power.

Under a further aspect if necessary a further activation can take place, whereby this for example would only occur on the condition that for example the temperature in the vicinity of the identification module or upon possible derivation of this from a drive unit, in particular gear temperature, lies below a defined value. If the temperature is higher, there will be no data readout and the identification character still stored in the control device will be used. In this case there will also be no updating of the operating and/or functional data storage unit.

A data readout from the identification module can then take place

a) at predefined intervals and/or

b) upon startup of the vehicle, for example by initiation of the ignition process or in general when the control device is supplied with power or

c) if necessary.

The storage of operating and functional data occurs in a non-continuous activation of the connection between identification module and control device for example in accordance with one of the following named possibilities:

a) at specified time intervals (after specified period of time or

a specified number of operating hours)

b) if necessary

c) upon termination of a driving operation

d) after interruption of supplying the control unit with power.

In all cases—a through d—the data is read out from the control unit and stored in the identification module.

Since in accordance with the invention an activation of the properties storage unit only takes place on specific conditions, the device further comprises at least one facility for gathering at least one variable that triggers activation. Corresponding with the above-mentioned possibilities this facility can be

a) a facility for recording at least one variable directly or indirectly characterizing the startup operation of a vehicle and/or the activation of the gear control unit, for example the operation of the ignition key,

b) a facility for recording at least one variable describing at least indirectly the termination of the driving operation or deactivation of the gear control unit and/or

c) a facility for recording a variable at least indirectly describing a specified thermal behavior of the identification module and/or of the drive unit, particularly of the gearbox.

These facilities are preferably designed in the form of sensors, by means of which corresponding signals for processing are generated in the control unit. Preferably these facilities are allocated to the control unit of the gearbox as independent units and coupled with them, whereby the control of a facility for creating the connection and/or data exchange and communication with the properties storage medium occurs by means of the control unit of the gearbox.

In an especially advantageous embodiment two lines are allocated to the gear control unit, a first supply line, which for example is at least indirectly coupled with a facility for starting the vehicle and a second so-called permanent plus line. The activation of the identification module can take place in the following manner: Upon activation of the ignition the control unit is supplied with current by the supply line. This activates the connection to the identification module, from which the property and/or operating and/or functional data are read out. After the readout or during the readout an activation of the permanent plus line takes place, through the control device. The control device can be provided with a corresponding intelligence, so that it is automatically able to store the current property and/or operating and/or functional data in the properties and/or operating data storage unit or trigger the storage within specific pre-determined intervals. Upon termination of the driving operation or deactivation of the gear control unit an interruption of the power supply occurs through the supply line. Since the supply however is still guaranteed via the permanent plus line , a storage of data can take place, including a larger data quantity, without problems in the identification module. Not until after storage is the supply of current interrupted over the permanent plus line by the control device.

A further aspect of the invention provides that a storage of current data deposited in the control device in the identification module generally takes place at specified time intervals.

In addition, to avoid errors, preferably a double or multiple storage of the data in the identification module is performed, whereby the storage unit is divided into at least two blocks, which are either provided a counter for its validity or generally are written to alternately.

The structural integration of the identification module in the drive unit presents itself in ideal manner for storage of drive unit-relevant operating data. The data can therefore upon exchange of the control unit allocated to the drive unit no longer be lost, in particular even their allocation to each other can be retained perfectly. In connection with the identification module this data can now be stored drive-unit-specifically and is preserved even after an exchange of the control device, whereby in the exchange of the control device type with this data that has already been optimized often during prior operation the optimum operating programs for controlling the drive unit in the control unit of the drive unit can be determined very quickly. Examples of such data are the wearing ability and revolutions, load collective, operating hours, wearout-specific variables and so on.

The identification module is preferably connected with the drive unit by means of a serial interface, in order to minimize the cabling expenditure. In the simplest case a memory chip with an integrated serial interface can be used so that the entire identification module for example consists only of a memory chip and some additional electronic equipment. Theoretically however, there is also the possibility of designing the identification module to be more complex, whereby it contains for example a microcomputer in which such a memory is either integrated or is connected with such a memory. Volatile storage units are used as memory, for example in the form of EEPROM, which has the advantage that the memory cells can be written to individually and the stored data can be preserved even without voltage supply.

The invention's solution is especially well suited for drive units in the form of gearboxes and retarders. Particularly in use in gears the arrangement occurs preferably in the area of or near to the socket arranged on the case.

The invention's solution is explained in the following using figures. In particular, they show the following:

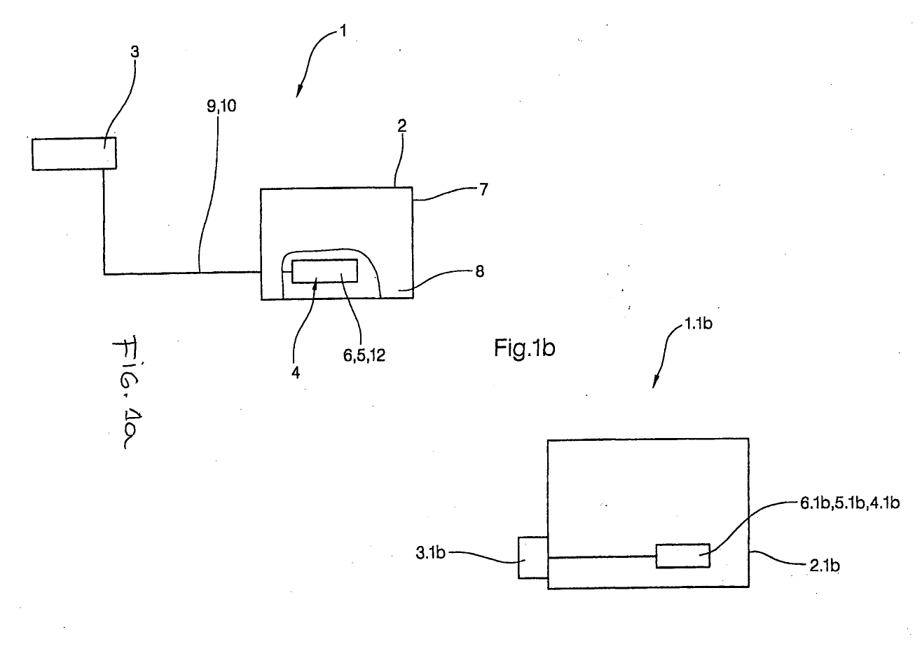

FIGS. 1a and 1b illustrate in greatly simplified schematic representation the basic structure of devices designed in accordance with the invention for controlling a drive unit in the form of a gearbox;

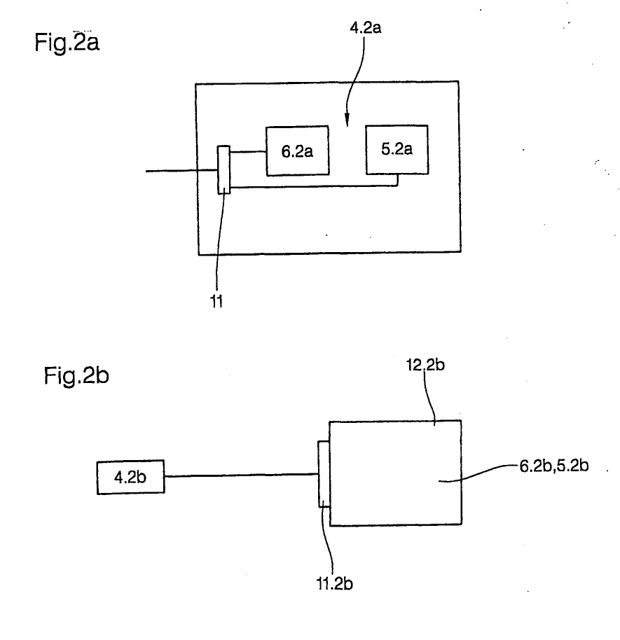

FIGS. 2a and 2b illustrate in greatly simplified schematic representation the basic structure of identification modules designed in accordance with the invention;

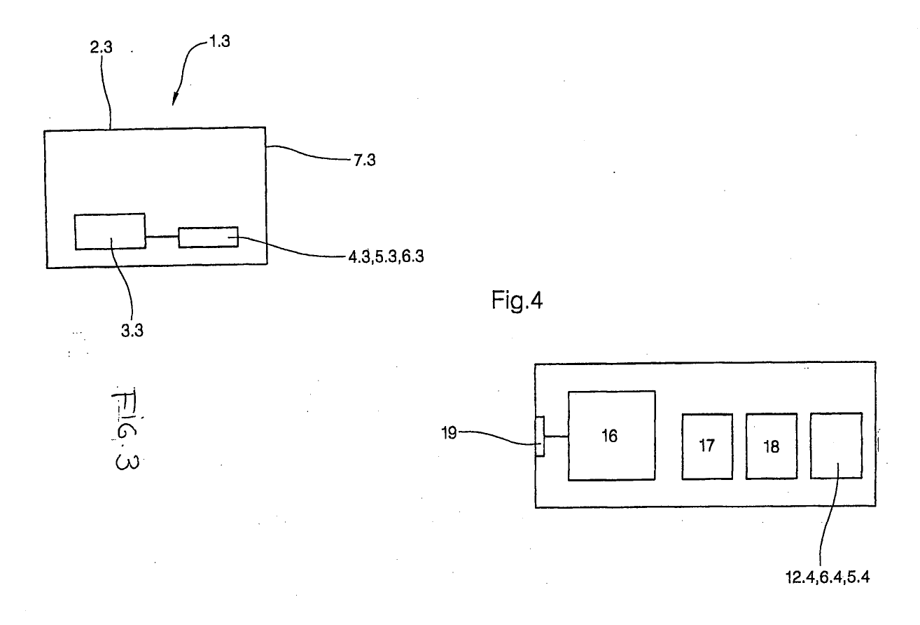

FIG. 3 illustrates an especially advantageous construction of a device designed in accordance with the invention for controlling a gearbox

FIG. 4 illustrates a construction of an identification module;

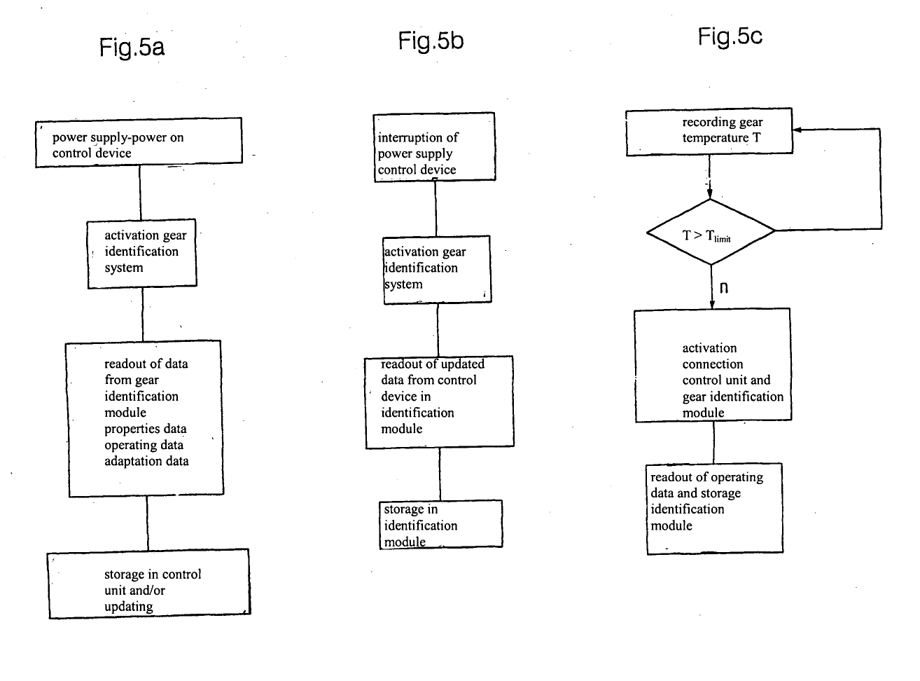

FIGS. 5a through 5c illustrate the possibilities in accordance with the invention for activating an identification module in accordance with the invention using signal flow diagrams.

FIG. 1 illustrates in greatly simplified schematic representation the basic structure of a device 1 designed in accordance with the invention for controlling a drive unit, preferably in the form of a gearbox 2. This comprises an electronic control unit 3, which is allocated to the gearbox 2 and can be arranged at any distance from it in the vehicle. Further the device 1 comprises an identification module 4 with a properties storage unit 5 for storage of at least manufacture-conditioned properties of controllable devices and components of the gearbox. In accordance with the invention the identification module 4 comprises further an operating data storage unit 6. The identification module 4 is in accordance with the invention integrated in the gearbox 2, that is in the gear case 7. Any arrangement within the gearbox 2 can be selected, preferably however an arrangement will take place viewed in fitting position in the lower gear part 8 and/or in the vicinity of the cable connection on the case and in thermally low stressed areas. The identification module 4 is electrically connected with the control unit 3 allocated to the gearbox 2. This connection occurs by means of resources 9 for communication and data transfer. Preferably the resources 9 comprise data transfer lines 10 and if a serial data transfer is desired, a serial interface 11. The properties storage unit 5 and the operating data storage unit 6 are preferably integrated in one memory unit 12. The memory unit 12 can be designed in such a way that in accordance with FIG. 2a the properties storage unit 5.2a and the operating data storage unit 6.2 are formed by different components, each of which is connected electronically with the serial interface 11. Both are preferably structurally combined in the memory unit 12.2a. With regard to function, the functions of storage of the manufacture-conditioned properties of controllable devices and of components of the automatic gear and the storage of operating data will be performed here by different components.

FIG. 2b illustrates in simplified schematic representation an especially advantageous possibility of designing a gear identification module 4.2b, in which the memory unit 12.2b comprises merely a memory unit which combines the functions of the properties storage unit 5 and of the operating data storage unit 6.2b with each other. This memory unit can form the memory unit 12.2b in its entirety, however, the possibility also exists of having this memory unit be just a component of memory unit 12.2b. In both cases the memory unit assuming the function of properties storage unit 5.2b and operating data storage unit 6.2b is connected with the control unit 3.2b via a serial interface 11.2b. The serial interface is preferably arranged either in the area of the memory unit 12.2b, right on it or integrated in it.

The configurations described in FIGS. 2a and 2b for the functional division of the functions—properties storage unit 5 and operating data storage unit 6—can be used in every design of the arrangement of the identification module 4 in a device 1 for controlling a gearbox. Further possibilities are described in FIGS. 1b and 3. In accordance with FIG. 1b the identification module 4.1b is arranged with operating data storage unit 6.1b and properties storage unit 5.1b in the gearbox 2.1b, while the control device allocated to gearbox 2.1b is arranged at an exterior casing wall 13.1b of the gearbox 2.1b. In contrast, FIG. 3 discloses a further second development, in which the control unit 3.3 is arranged in the gear casing 7.3 of the gearbox 2.3, that is, is integrated in the gearbox 2.3 and the arrangement of the identification module, particularly gear identification module 4.3 with operating data storage unit 6.3 and properties storage unit 5.3 in the gearbox 2.3 occurs in the immediate physical vicinity, preferably directly next to each other or on top of one another. With this design the cabling expenditure between control unit 3.3 and identification module 4.3 is minimal. This solution is useful with different suppliers of gearboxes and control units.

With the designs in accordance with FIGS. 1a and 1b however, it is necessary to install the interconnection line required for electrical coupling between the control unit 3 and the gear identification module 4 through the gear casing 7, in particular a wall of gear casing 7.1.

For all designs in accordance with FIGS. 1 through 3, it holds true that the identification module 4 designed in accordance with the invention represents an electronic system structurally connected with the gearbox 2, whose most important elements are the memory units for operating data and the properties storage unit. In the production of the gear, among others the gear type, the gear design and the serial number are stored in coded form in identification module 4 in the properties storage unit 5. The properties storage unit 5 represents a kind of electronic identification plate for storage of manufacture-conditioned properties of controllable devices and components of the automatic gearbox. Through the identification module 4 the control unit 3 gets the opportunity to adapt itself automatically to the design of the gear, that is, all design-specific settings and functions which have an effect on the gear performance or the necessary control of gearbox 2 are taken from the identification system, and the appropriate software can be selected and activated in control unit 3. This solution makes it possible to significantly reduce the data records with regard to length. In the process the data record restricts itself essentially to the client-specific or vehicle-specific settings. The control unit 3 automatically performs all design-specific settings. The storage of current operating data in operating data storage unit 6 offers the option that even in the case of an exchange of control unit 3 the data or its allocation to a specified gearbox 2 does not get lost. This data includes, among others, the wearing ability, operating hours, load collective, specifications on the switching behavior, in particular the behavior of the individual elements involved in the switching operations and others.

FIG. 4 illustrates a further especially advantageous design of an identification module, particularly a gear identification module 4.4. It is designed as a complex system and comprises a microcomputer 14, that is an integrated circuit which consists of a microprocessor 16 as central processing unit, at least one read-only memory 17 for the storage of programs and/or a read-write memory 18 for the storage of data as well as an interface 19 for communication in other systems as well as storage units for properties, operating and functional data—operating and/or functional data storage unit 6.4 and properties storage unit 5.4, whereby the individual memory units can be formed by a physical memory 12.4 or are not shown here with regard to their function of separated components. The memory unit 12.4 is preferably designed as EEPROM, which has the advantage that the memory cells can be written to individually and the stored data is preserved even without voltage supply. This means that preferably non-volatile memory is used.

As a rule further control electronics are required to implement the mode of operation, in order to make data transfer possible via the voltage supply lines and to minimize the cabling expenditure. However, this depends on the specific system selected for gear identification.

FIG. 5a uses a signal flow diagram to illustrate the basic mode of operation of an identification module 4 designed in accordance with the invention in a device 1 for controlling a gearbox 2. The identification module 4 is only activated for a short time in supplying the control device with current, for example in starting the drive device in a vehicle, in order to read out the identification from the identification module 4 by means of the gear control unit 3. For this purpose the electronic connection between control unit 3 and identification module 4 is activated. The data is read out from properties storage unit 5, in addition, there is the choice of reading out the current operating data optionally, or always, from the operating data storage unit 6. This data is transmitted by means of the resources 9 to the control unit 3, which is allocated to the gearbox, and processed there or stored in a memory unit provided for this or also other purposes or just passed on to a further higher-ranking control system either under temporary storage or without temporary storage.

For consideration of the operating and/or functional data already determined for different control purposes or also for evaluation purposes, the current operating and/or functional data in accordance with FIG. 5b is, upon interruption of the supply of current to the control device, for example upon the termination of a driving operation, that is upon shutdown of the gearbox 2, automatically read out of the control unit and deposited in the gear identification module 4. This occurs either in dependency of a variable indicating a desired or required deactivation of a control unit and thus connected to the interruption of the supply of current or with designs of control units with additionally allocated permanent plus line and time delayed activation of this upon putting the control unit into operation after interruption of the supply of current when the permanent plus line is still active, i.e. with provision of a follow-up phase for storage. The current property and/or operating and/or functional data, which for example is stored in a memory unit integrated in control unit 3, is fed to the operating and functional data storage unit 6 and/or the properties storage unit and stored there by means of the connection between control unit 3 and gear identification module 4.

A further aspect of the invention in accordance with FIG. 5c provides that in the presence of a very high environmental temperature for the identification module 4 closing variable an automatic readout of the current operating data and the currently valid data is prevented and that this operation is only allowed at lower temperatures. In the process, by means of at least one resource for recording the temperature in one or more of the assumed critical areas at the identification module or the environment or upon possible derivation of these temperatures from any determined temperature in the drive unit or the gearbox, records a variable at least indirectly determining the thermal behavior in this area and compares it with a predeterminable limit value of Tₗᵢₘᵢₜ. If the current temperature actual value is lower than the predeterminable maximum temperature limit, a readout of the current operating data automatically occurs by activation of the connection between control unit 3 and gear identification module 4. The identification module is only activated if the gear temperature lies below a defined threshold.. If the temperature is above that threshold, the control unit uses the identification stored in the control unit 3. A standard temperature sensor present at or in the gearbox is used for determination of the temperature. This can also be transferred in analogy to the storage of updated data in the identification module.

### List of Reference Symbols

1, 1.2b, 1.3 Device for controlling a gearbox

2, 2.1b, 2.3 Drive unit, gearbox

3, 3.1b, 3.3 Control unit

4, 4.1b, 4.2a

4.2b, 4.3, 4.4 Identification module, gear identification module

5, 5.1b, 5.2a

5.2b, 5.3, 5.4 Properties storage unit

6, 6.1b, 6.2a

6.2b, 6.3, 6.4 Operating data storage unit

7, 7.1a, 7.1b, 7.3 Gear casing

8 Bottom gear part

9 Resources for communication and data transfer

10 Data transfer lines

11, 11.2a, 11.2b Serial interface

12, 12.2a, 12.2b

12.24 Memory unit

13, 13.1b Exterior casing wall

14 Microcomputer

15 Electrical coupling

16 Microprocessor

17 Read-only memory

18 Read-write memory

19 Interface

1. Device (1; 1.1b) for electronically controlling a drive unit, particularly a gearbox (2; 2.1b) for use in vehicles;
1.1 with a control unit (3; 3.1b; 3.4) allocated to the drive unit (2; 2.1b) and arranged at a distance from the drive unit (2; 2.1b);
1.2 with an identification module (4; 4.2a; 4.2b; 4.4) electrically connected with the control unit (3; 3.1b), comprising a properties storage unit (5; 5.2a; 5.2b; 5.4) allocated to the drive unit (2; 2.1b) for storage of at least manufacture-conditioned properties of controllable devices and components of the drive unit (2; 2.2b); characterized by the following features:
1.3 the identification module (4; 4.1b; 4.2a; 4.2b; 4.4) is arranged in the drive unit, particularly in its casing (2; 2.1b);
1.4 the identification module (4; 4.1b; 4.2a; 4.2b; 4.4) further contains an operating and/or functional data storage unit (6; 6.1b; 6.2a; 6.2b; 6.4) for storage of updated operating data and/or functional data.

2. Device (1.3) for electronically controlling a drive unit, particularly a gearbox (2.3), particularly an automatic gearbox for use in vehicles
2.1 with a control unit (3.3) allocated to the drive unit (2.3) and arranged on or in the casing of the drive unit;
characterized by the following features:
2.2 with an identification module (4.3) electrically connected with the control unit (3.3), comprising one properties storage unit (5.3) allocated to the drive unit (2.3) for storage of at least manufacture-conditioned properties of controllable devices and components of the drive unit (2.3);
2.3 the identification module (4.3) is arranged in the drive unit (2.3), particularly in its case;
2.4 the identification module (4.3) contains an operating and/or functional data storage unit (6.3) for storage of updated operating data and/or functional data.

3. Device (1; 1.1b; 1.3) according to claim 1 or 2, characterized by the fact that the properties storage unit (5; 5.1b; 5.2a; 5.2b; 5.3; 5.4) and the operating and/or functional data storage unit (6; 6.1b; 6.2a; 6.2b; 6.3; 6.4) are formed by a memory unit (12; 12.1b; 12.2b; 12.3; 12.4)

4. Device (1; 1.1b; 1.3) according to claim 3, characterized by the fact that the memory unit (12; 12.1b; 12.2b; 12.3; 12.4) is formed by a non-volatile memory, particularly an EEPROM (12.4).

5. Device (1.4) according to one of claims 1 through 4, characterized by the following features:
5.1 The identification module (4.4) comprises a microcomputer (14), comprising a microprocessor (16) with at least one read-only memory (17) for the storage of programs and at least one read-write memory (18) for the storage of data;
5.2 with an interface (19) for communication with other systems;
5.3 the operating and/or functional data storage unit (6; 6.1b; 6.2a; 6.2b; 6.3; 6.4) and the properties storage unit (5; 5.1b; 5.2a; 5.2b; 5.3; 5.4) are integrated in the microcomputer (14).

6. Device (1; 1.1b; 1.3) according to one of claims 1 through 5, characterized by the fact that the control unit (3; 3.1b; 3.3; 3.4) and the identification module (4; 4.1b; 4.2a; 4.2b; 4.3; 4.4) are coupled with each other by resources (9) for communication and data transfer.

7. Device (1; 1.1b; 1.3) according to claim 6, characterized by the fact that the resources (9) comprise a serial data transfer and communication facility (11).

8. Device (1; 1.1b; 1.3) according to claim 7, characterized by the fact that the properties storage unit (5; 5.1b; 5.2a; 5.2b; 5.3; 5.4) and/or the operating and/or functional data storage unit (6; 6.1b; 6.2a; 6.2b; 6.3; 6.4) and the interface (19) form one structural unit.

9. Device (1; 1.1b; 1.3) according to claim 6 through 8, characterized by the fact that the resources (9) comprise a voltage supply line which simultaneously is the line for communication.

10. Device (1; 1.1b; 1.3) according to one of claims 1 through 9, characterized by the fact that the control unit (3; 3.1b; 3.3;) of the drive unit can be interconnected with a central control unit in the vehicle of higher ranking.

11. Device (1; 1.1b; 1.3) according to one of claims 1 through 9, characterized by the fact that the control unit (3; 3.1b; 3.3;) is integrated in a central device for controlling a vehicle.

12. Device (1; 1.1b; 1.3) according to one of claims 1 through 11, characterized by the fact that two supply lines are allocated to the control unit—a first supply line and a second permanent plus line, whereby the power supply of the permanent plus line can be deactivated by means of the control unit.

13. Device (1; 1.1b; 1.3) according to one of claims 1 through 12, characterized by the following features:
13.1 The operating and/or functional data storage unit and the properties storage unit can be split up into at least two blocks;
13.2 a counter or an identification about its validity is allocated to each block.

14. Device (1; 1.1b; 1.3) according to one of claims 1 through 13, characterized by the following features:
14.1 with a facility for recording at least one variable characterizing at least indirectly the startup operation of the vehicle;
14.2 with a facility for processing the variable characterizing at least indirectly the startup operation of the vehicle or the activation of the control unit of the drive unit and formation of a correcting variable for controlling a facility for activation of the communication and data transfer between the control unit (3; 3.1b; 3.3; 3.4) and the gear detection system (4; 4.1b; 4.2a; 4.2b; 4.3; 4.4).

15. Device (1; 1.1b; 1.3) according to one of claims 1 through 14, characterized by the following features:
15.1 with a facility for recording at least one variable at least indirectly describing the termination of a driving operation or the deactivation of the control unit of the drive unit;
15.2 with a facility for processing the variable at least indirectly characterizing the termination of a driving operation of the vehicle or the deactivation of the control unit of the drive unit and formation of a correcting variable for controlling a facility for activation of the communication and data transfer between the control unit (3; 3.1b; 3.3; 3.4) and the gear detection system (4; 4.1b; 4.2a; 4.2b; 4.3; 4.4).

16. Device (1; 1.1b; 1.3) according to one of claims 1 through 14, characterized by the following features:
16.1 with a facility for recording a variable at least indirectly characterizing the temperature of the identification module;
16.2 with a facility for processing the variable at least indirectly characterizing the temperature of the identification module of the vehicle and formation of a correcting variable for controlling a facility for activation of the communication and data transfer between the control unit (3; 3.1b; 3.3; 3.4) and the gear detection system (4; 4.1b; 4.2a; 4.2b; 4.3; 4.4).

17. Device (1; 1.1b; 1.3) according to one of claims 13 through 15, characterized by the fact that the facility for formation of the correcting variable for controlling a setting facility is formed by the control unit (3; 3.1b; 3.3) of the gearbox.
